(19) United States
(12) Patent Application Publication
(10) Pub. No.: US 2019/0318845 A1
(43) Pub. Date: Oct. 17, 2019

(54) WIRING TERMINAL FACILITATING IDENTIFICATION OF CORRECT WIRING

(71) Applicant: XI'AN BLUE DIAMOND ELECTRONIC TECHNOLOGY CO., LTD, Xi'an (CN)

(72) Inventor: Shuiping WANG, Xi'an (CN)

(73) Assignee: XI'AN BLUE DIAMOND ELECTRONIC TECHNOLOGY CO., LTD, Xi'an (CN)

(21) Appl. No.: 16/314,498

(22) PCT Filed: Jul. 4, 2017
(86) PCT No.: PCT/CN2017/091578

§ 371 Date: Dec. 31, 2018

(30) Foreign Application Priority Data
Jun. 30, 2016 (CN) 201610506350.4

(51) Int. Cl. H01B 7/36; H01R 13/46

(52) U.S. Cl. CPC H01B 7/368; H01R 13/465

(57) ABSTRACT

A terminal for facilitating identification of an accurate wiring, including a casing and a plurality of terminals, the terminal being extended from the inside of the casing. The casing is provided with a plurality of marking zones; one-to-one correspondence with the terminals. An easy-to-identify identification area on the connection terminals of various circuit connecting devices such as a socket, a plug, a knife switch, an air switch, a circuit breaker, an electric meter, a motor, a transformer, a power line, a generator or a transformer, and different terminals is provided. The corresponding identification areas are set with different colors and sorting. The characters of each country can facilitate the technical personnel or ordinary users to accurately distinguish and identify different terminals such as live wire, naught wire and earth wire. The colored identification areas correspond to different color power lines.

### TECHNICAL FIELD

The invention relates to a terminal for facilitating the identification of an accurate wiring.

### RELATED ART

With the level of social industrialization and the improvement of people's economic income, more and more types of household appliances are appearing in people's daily lives, including various electrical equipment, such as control cabinets, switch cabinets, switches, and instrument boxes, computers, televisions, air conditioners, refrigerators, washing machines, electric cars, and so on. The internal strong parts of these electrical equipment usually use two-phase or three-phase power lines for power input, while China's two-phase plugs and sockets have the disadvantage of not dividing them up and down. In order to ensure the stability of the voltage input and the safety considerations for power consumption, for some high-power electrical equipment, it is necessary to use a power cord with a four-hole plug or even a five-hole grounding plug, although the professional English is the first. Letters or symbols are given to the logo. It is easy for the ordinary people to make mistakes during wiring or how to properly wire them. It is easy to have wiring errors. In addition, from the power station to the booster station, substation, switch station, low-voltage transformer and then to the user's terminal electrical equipment, the entire circuit transmission process requires the use of a large number of terminals, switches, fuses, arresters, etc. for circuit switching, easy A wiring error condition has occurred. In the process of power generation, electricity or circuit switching, the live wire, naught wire, earth wire and phase sequence of the transmission line should be distinguished. However, various types of power generation equipment and transformers are currently being sold and in use on the market. The terminals of the equipment or electrical equipment are not effectively marked, displayed in and out, and color sorted. For technicians and ordinary users who are not familiar with the relevant regulations, it is very easy to have the intersection of the live wire, naught wire, earth wire or phase sequence disorder, and the average user cannot accurately identify the hot line, the zero line and the position order. For weak multi-position connection terminals, such as military connection plugs and sockets, aviation jacks, TVs, computer plugs and sockets, etc. (10-20 holes or more), the assembly wiring is more error-prone, the detection difficulty is higher, and multiple disconnection faults occur. It is difficult to recover, especially the military connection plug and socket in the battlefield environment, it is very important to fix it quickly after damage.

### SUMMARY

In order to solve the technical problem that the existing terminal terminals are not effectively marked, corresponding to the display power source polarity and color sorting, the present invention provides an obvious color frame mark, color block, ribbon, wire pattern, number, direction arrow, A color guide wire or a terminal that is marked and raised in the country to improve wiring accuracy.

The technical solution of the present invention is: a terminal for facilitating identification of an accurate wiring, comprising a housing and a plurality of terminals, the terminals being extended from the inside of the housing, the special being that: the housing is provided with a plurality of The identification area; the identification area has a one-to-one correspondence with the terminal.

The marking zone is a planar marking, projection, groove or integral multi-color injection molding on the outer or inner surface of the outer casing.

The above identified area is a combination of one or more of color patches, ribbons, directional arrows, wire patterns, numbers, and characters.

The above color patches are color patches that are round, circular, square or square around the terminals.

The ribbon is a guide line that is connected to one end of the terminal.

The above characters are one or several combinations of “ [symbol] ”, “ [symbol] ”, “ [symbol] ”, “ [symbol] ”, “ [symbol] ”, “ [symbol] ”, “ [symbol] ”, “ [symbol] ”, “N” and “L”.

The above terminals are sockets, plugs, knife switches, air switches, circuit breakers, electric meters, motors, connecting terminals, generators, or terminals on transformers.

The above directional arrows are provided on the terminal itself or on the surface of the power cord or housing.

The number of the above-mentioned directional arrows is plural, reflecting the relationship between the entry and exit.

The protrusions or grooves are one or more, and the shape of the protrusions or grooves is circular or square.

The invention has the beneficial effects that the invention is easy to identify on the terminals of various circuit connecting devices such as sockets, plugs, knife switches, air switches, circuit breakers, electric meters, motors, transformers, power lines, generators or transformers. The identification area and the identification area corresponding to different terminals are set with different colors and sorting. The characters of each country can facilitate the technicians or ordinary users to accurately distinguish and identify different terminals such as the live wire, naught wire and earth wire, and the colored identification areas are different. The color power line can achieve the uniformity of color and phase sequence. It can be easily and accurately returned after accidental disconnection, and ordinary people can connect correctly. It not only improves the wiring security but also increases the wiring convenience, greatly improves the efficiency of wiring by technicians or ordinary users, and is also applied to signal transmission networks such as fiber switches and network cable switches. In addition, single or multi-strand power cords are provided with directional arrows to indicate the power direction. The color-coded terminal blocks provided by the present invention are applied to sockets, plugs, plugs, etc., which are easy to identify, improve the accuracy of accurate wiring, and set two-phase plugs. The color mark enables the socket fire wire to be accurately connected to the fuse end of the electrical equipment to avoid charging the entire power supply circuit after the fuse is blown due to the reverse connection, thereby improving the safety of the electric power, especially the color and position of the terminals of the generator and the motor. And the definition of the phase, that is, the left, yellow, green, red, light blue (blue) of the terminal, and the phase sequence rotate clockwise, that is, it is easy to realize the parallel transmission from the source generator to the terminal motor, and the uniformity of the color and order of the marking area. Regardless of how many booster stations, substations, switchyards, low-voltage transformers, transmission circuits, etc. pass through, the purpose of the present invention can be achieved, and the correct wiring is guided. After the implementation of the present invention, the motor of this embodiment is connected to any of the load terminals. It can realize clockwise rotation, that is, the same as the generator steering, and also avoid the existing AC three-phase A\B\C is equal to the AC three-phase B\C\A and AC three-phase C\B\A, that is, the problem of consistent steering and line crossing. It is easy to realize the three-phase parallel or multi-layer connection of AC three-phase A\B\C through the color identification area. The line is accurate and is especially suitable for frequently transferring buried cables.

The above improvements are applied to the terminals of electrical switches such as knife switches, air switches, circuit breakers, electric meters, AC contactors, fiber optic connectors, etc., while limiting the color of the wiring at the terminals, which in turn limits the color and direction of the power lines. It plays a role of connecting the upper and lower. Even if the wiring of the common user refers to the color and direction arrow, it can reach the professional wiring level. Understand the power supply direction, and can standardize the existing products, which can be widely used in power control cabinets, switch cabinets, instrument boxes, In switches and other devices, the advantages are clear connection between power supply and signal, eliminating wiring errors, installation specifications, operation by ordinary users, and greatly enhanced security, especially suitable for battlefield chaos.

### BRIEF DESCRIPTION OF DRAWINGS

FIG. 1 is a schematic structural view of Embodiment 1 of the present invention;

FIG. 2 is a schematic structural view of Embodiment 2 of the present invention;

FIG. 3 is a front elevational view showing a third embodiment of the present invention;

FIG. 4 is a schematic diagram of an internal structure of Embodiment 4 of the present invention;

FIG. 5 is a schematic structural view of Embodiment 5 of the present invention;

FIG. 6 is a schematic structural view of Embodiment 6 of the present invention;

FIG. 7 is a schematic structural view of Embodiment 7 of the present invention;

FIG. 8 is a schematic structural view of Embodiment 8 of the present invention;

FIG. 9 is a schematic structural view of Embodiment 9 of the present invention;

FIG. 10 is a schematic structural view of Embodiment 10 of the present invention;

FIG. 11 is a schematic structural view of Embodiment 11 of the present invention;

FIG. 12 is a schematic structural view of a double core sheathed wire used in conjunction with the present invention.

### DESCRIPTION OF EMBODIMENTS

### Embodiment 1

The terminal of the invention can be applied to the front or back wiring part of the AC charging plug socket of the new national standard electric vehicle, and is also applicable to the British standard, the American standard, the European standard, the South African standard or other national military, civil, industrial, aviation plugs and sockets, etc., including square, round two-hole, three-hole, four-hole, five-hole and seven-hole, nine-hole electric car plug and socket and porous plug and socket, that is, two-phase plug and socket square round (L, N), two-phase with ground Line plug socket square round (L, N, E), three-phase ground wire plug socket square round (L1, L2, L3, E), civil or industrial five-hole plug socket square round (L1, L2, L3, N, E) and other combinations.

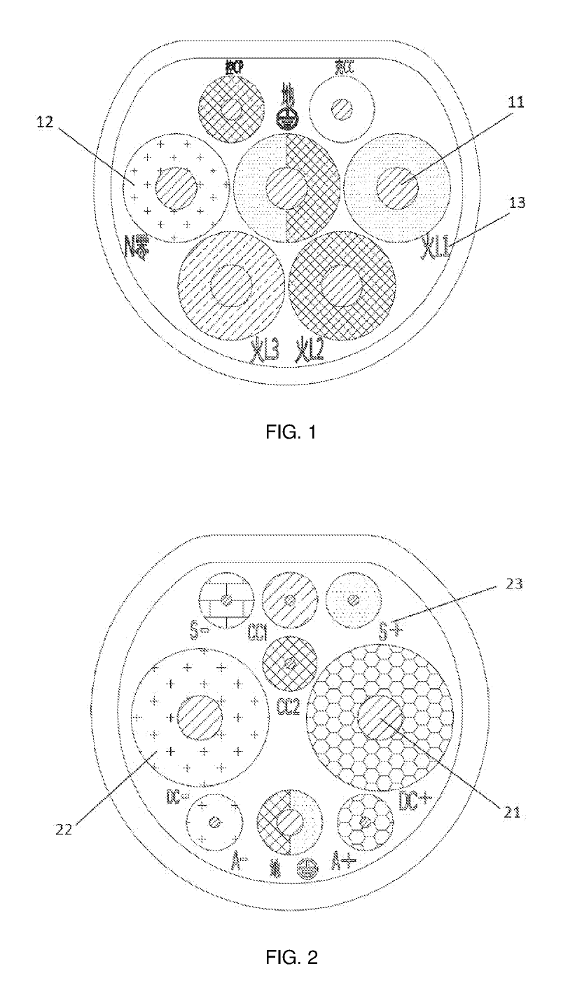

Referring to FIG. 1, this embodiment is a new national standard electric vehicle AC charging plug, and the terminals are seven copper plug sockets 11, and a circular color block of different colors is arranged around each copper plug socket 11. 12. A Chinese and English character 13 of the same color is placed next to the color block 12. Among them, “ [symbol] L1” and corresponding color blocks are yellow, “ [symbol] L2” and corresponding color blocks are green, “ [symbol] L3” and corresponding color blocks are red, “N [symbol] ” and corresponding color blocks are blue (light blue) The “ [symbol] CC” and the corresponding color block are white, the “ [symbol] CP” and the corresponding color block are yellow, and the “ [symbol] ” and the corresponding color block are yellow-green two-color. The new color labeling also includes a plastic column (empty core) surrounding the tail part of the plug socket, adding color to the exterior or interior of the plastic column. The purpose of adding color is not only eye-catching, easy to recognize, but also the color of the connecting wire sheath. Restricted, refer to the regulations of China's AC three-phase five-wire color, DC power cord and control line color; color setting (printing or injection molding, etc.) on the bottom casing surface of the plug socket or the top casing surface of the socket insert, surrounding the plug socket The shape is square or round, etc., so that when people see the color of the bottom of the plug and the surface of the top of the insert, the first reaction is red for the live wire, blue (light blue) for the Naught Wire, yellow and green for the Earth, Brown represents DC positive pole, dark blue represents DC negative pole, etc. It can also reflect three-phase five-wire sorting. It is also the purpose of the present invention, and has certain warning functions. It is suitable for different plug sockets in various countries, such as the Yueqing Maifeng Instrument&Connector Co., Ltd.'s CB2 series, CX series, CY series, GX series, P series, Y2M series, YD series, secondary type connector series, HD XBSCN heavy-duty connector and other plugs, but the color should meet the different requirements of different countries, such as the American standard live wire is black, blue (light blue), red, naught wire is white, and the British standard live wire is brown, black, gray, South Africa standard live wire is red, yellow, blue (light blue), and the naught wire is black. Most users will consciously match the color when the two-phase plug is inserted into the socket, that is, red to red, blue (light blue). For blue (light blue), the color difference is obvious after the wrong connection, and it is easy to find the wrong operation. The color adopts the printing or inkjet printing process, and the eye-catching hint is strong and long-lasting. The added color can reflect the polarity of the upper and lower corresponding plugs and sockets, that is, the live wire, the naught wire, the earth, etc. When the terminal is applied to the weak current circuit, the color of the weak electric signal portion should be selected to avoid the strong electric color setting.

### Embodiment 2

The terminal block of the invention can be applied to the front or back wiring part of the nine-hole DC charging plug socket of the new national standard electric vehicle, and is also applicable to the military, civil, industrial, aviation of the British standard, the American standard, the European standard, the South African standard or other countries. Plug and socket, wiring methods include crimping, welding, screw fixing cable, including square, round two-hole, three-hole, four-hole, five-hole and seven-hole, nine-hole electric car plug and other multi-position plug and socket, such as Taixing Airline Military Aviation Plug Co., Ltd.'s Y2 series, Y50 series, XC, Y27 series, YMG series, Y17 series, Y11, YP series, Y50X series, Y50EX, Y50DX series, XCA series, CXCH, XCM series, XCG series, XCE Series, XCF series, XCD, YGD series, JY series, J7 series, J14 series, YF1 series, YF6 series, etc.

Referring to FIG. 2, the present embodiment is a nine-hole DC charging plug for a new national standard electric vehicle. The terminals are nine copper plug sockets 21, and a round circle of different colors is arranged around each copper plug socket 21. The color block 22 is provided with a Chinese and English character 23 of the same color as the color block 22. Wherein, “S+” and the corresponding color block are yellow, “CC2” and the corresponding color block are green, “CC1” and the corresponding color block are red, “DC−”, “A−” and the corresponding color block are blue (shallow Blue), “S−” and corresponding color blocks are black, “DC+”, “A+” and corresponding color blocks are brown, and “ground” and corresponding color blocks are yellow-green two-color. The new color labeling also includes a plastic column (empty core) surrounding the tail part of the plug socket, adding color to the exterior or interior of the plastic column. The purpose of adding color is not only eye-catching, easy to recognize, but also the color of the connecting wire sheath. Restricted, that is, yellow corresponds to the yellow outer skin color wire, green corresponds to the green outer skin color wire, red corresponds to the red outer skin color wire, blue (light blue) corresponds to the blue (light blue) outer skin color wire, and yellow-green two-color corresponds to the yellow-green two-color outer skin color. The wire, the black corresponding to the black outer skin color wire, the brown corresponding to the brown outer skin color wire, the above improved ordinary user through the color is easy to correspond to the wiring, reducing the difficulty of identification, but also facilitates assembly detection, the color difference is obvious after the wrong connection, and it is easy to find misoperation. In the event of multiple breaks, users can easily and accurately connect through colors, while traditional products cannot be connected except for professionals. The color of the tail of the plug sleeve defines the color of the wire and the color of the plug sleeve, and the invention plays a role of connecting the upper and lower sides, so that the two cables are accurately connected through the plug and socket, that is, the color is color. The color is printed or inkjet, which is eye-catching and long-lasting. Applicable to different plugs and sockets in different countries, but the color should meet the different requirements of different countries.

### Embodiment 3

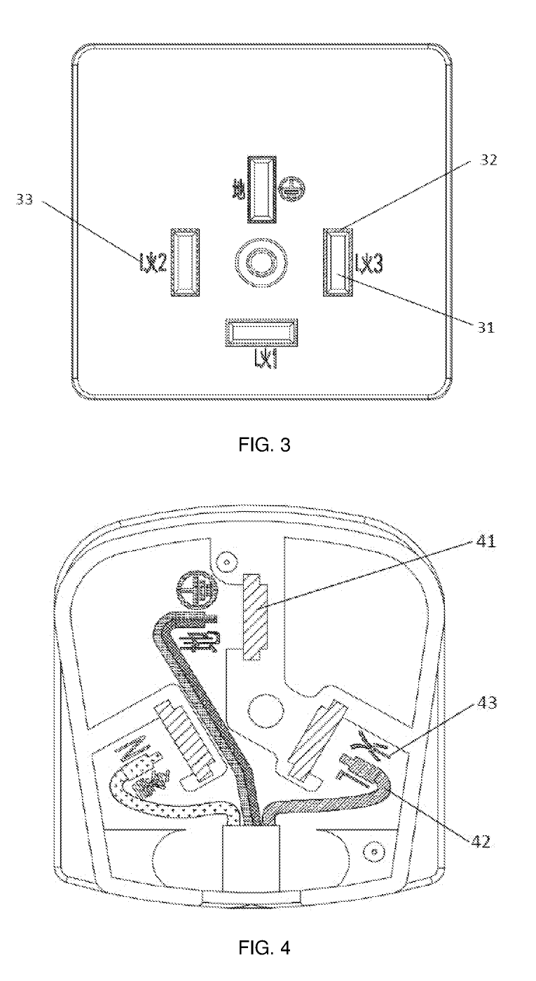

Referring to FIG. 3, the embodiment is a front panel structure of a casing applied to a national standard three-phase socket, and the socket manufacturer includes Bull, Schneider, TCL, Siemens, and the like. The terminals are four socket jacks 31, and a square color block 32 of different colors is arranged around each socket jack 31, and the same color and color are set beside the color block 32. Character 33. Wherein, “L [symbol] 1” and the corresponding color block are yellow, “L [symbol] 2” and the corresponding color block are green, “L [symbol] 3” and the corresponding color block are red, “ [symbol] ” and the corresponding color block are yellow-green two-color, Another application of the plug and socket is to change the grounding to N zero, which is mostly applied to the generator (no need for the earth wire environment). In this way, when people see the color circle of the socket, the first reaction is red, yellow, green corresponding to the live wire, yellow and green two colors corresponding to the earth wire and corresponding to the polarity of the inner insert sleeve of the outer casing, etc., also applicable to square, circular single phase Single-phase with earth wire, three-phase plug socket and modular socket, etc. The color adopts printing or inkjet printing technology, which is eye-catching, alert and strong, and long-lasting. The added color can reflect the polarity of the upper and lower corresponding plugs and sockets, that is, the live wire, the naught wire, the earth wire, and the like.

### Embodiment 4

Referring to FIG. 4, this embodiment is applied to the national standard two-phase grounding square detachable plug, including 10a, 16a and other specifications plugs, manufacturers include Bull, Schneider, TCL, Siemens, etc., but also for single-phase, single-phase Internal wiring with earth wire, three-phase plug, power supply box, timer, thermostat, electronic instrument, socket, socket, switch, lamp holder, etc., can also be applied to air conditioners, washing machines, microwave ovens, modular sockets, etc. Electrical equipment, etc., wiring methods are crimping, welding, screw fixing cable. The terminal of the embodiment is three copper plugs 41, and each of the copper plugs 41 is provided with a strip of color strip 42 of different colors (ie, a power line guide line pattern), and the ribbon is also provided with the same color. Chinese and English characters 43. The ribbon 42 can guide people to accurately wire, and at the same time limit the color of the power cord, further standardize wiring and unification, to meet the general population operation, and reduce errors. Among them, “ [symbol] ”, “L” and corresponding color bands are red, “ [symbol] ”, “N” and corresponding color bands are blue (light blue), and “ [symbol] ” and corresponding color bands are yellow-green two-color. The color is printed or inkjet, which is eye-catching and long-lasting. Applicable to different plugs and sockets in different countries, but the color should meet the different requirements and habits of different countries. The color of the single-phase live wire in the marking area refers to the color and usage habits of the three-phase live wire in various countries. It is customary to use red in the fire line in China (three-phase fire line color 1 yellow, 2 green 3 red) The added color can reflect the polarity of the upper and lower plugs and sockets, that is, the live wire, the naught wire, the earth wire, etc., the color difference is obvious after the wrong connection, and it is easy to find misoperation.

### Embodiment 5

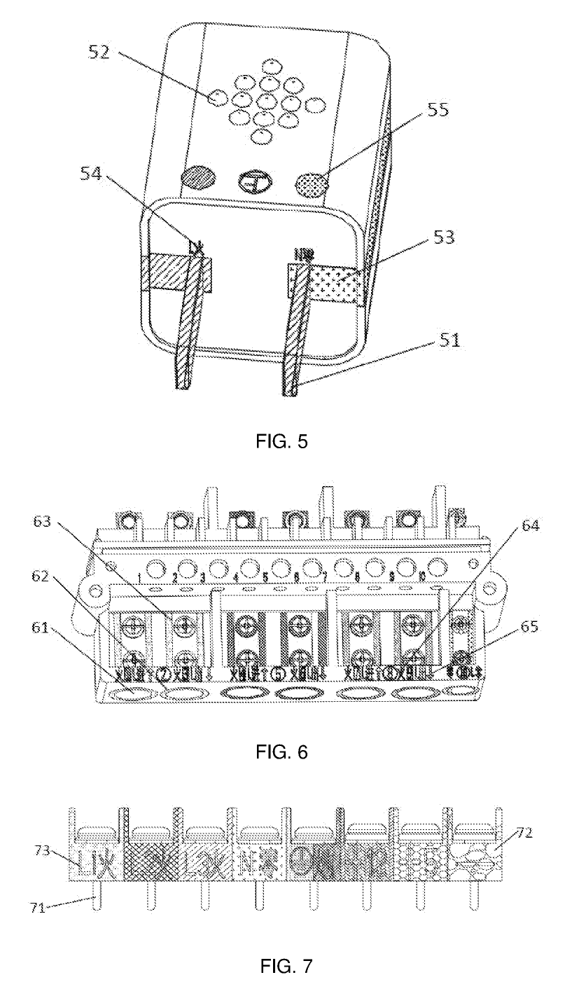

Referring to FIG. 5, the embodiment is applied to a mobile phone charger, and further includes an electrical device having a fuse and a leakage of a metal connecting component, such as a television, a hair dryer, an electric drill, a DVD player, a charger, a power supply box, and the like. Including square, round with or without wire, single-phase, single-phase with earth wire, three-phase plug, plug bracket and so on. The terminal of this embodiment is a two-phase plug 51, and the marking areas provided on the six faces of the peripheral surface of the casing include a dot-like projection 52, a strip-shaped ribbon 53, a Chinese-English character 54 and a circular color block 55. Among them, the “L [symbol] ”, the ribbon connected to the “L [symbol] ” and the color blocks above the “L [symbol] ” are red, the “N [symbol] ”, the ribbon connected to the “N [symbol] ” and the “N [symbol] ” The upper color blocks are all blue (light blue). In this way, when the charger is ready to be charged, the upper and lower sides of the text mark can be recognized. When the text is inserted into the wall socket, the electrode can be matched. The live wire corresponds to the contact circuit of the fuse, and people can also pass the point. Shaped protrusion 52 (feeling up and down, no visual inspection, poor light can also recognize the upper and lower, multiple insertion formation habits, can be accurately inserted into the wall panel socket without looking at the eyes, the purpose of setting the ribbon and color block is to correspond to the color of the socket Accurate insertion, popularize the basic common sense of the left naught wire of the right live wire, and at the same time make the product more beautiful, the main reason is to improve the safety factor, also set in the back of the shell, single phase, single phase with earth wire, three-phase plug, etc. The color block further shows the polarity of the plug sleeve and the phase sequence arrangement, which is convenient for people to observe and recognize from the back, especially for the plug bracket assembly wiring. The color is printed or inkjet, which is eye-catching and long-lasting. It is suitable for different countries. Plug and socket, but the color should meet the different requirements of different countries. The single-phase live wire color in the marking area refers to the three-phase live wire of each country. And the habit of using, China's customary use of red (three-phase live wire color 1 yellow, 2 green, 3 red) increased color can reflect the polarity of the upper and lower plugs, inserts, namely live wire, naught wire, earth wire, etc., most users When the two-phase plug is inserted into the socket, the conscious color corresponds, that is, red to red, blue (light blue) to blue (light blue), and almost all switches and fuses are connected to the red power line, that is, the live wire. The traditional national standard two-phase plug is difficult to distinguish the impact of accurate insertion, and the safety is poor. Once the plug is reversed, even if the switch is closed or the fuse is blown, the whole circuit will be in a charged state, which is prone to electric shock.

### Embodiment 6

Referring to FIG. 6, the embodiment is applied to a three-phase electric meter binding post. The manufacturer includes Cixi Zhouxiang Dengfa Hardware Fittings Factory, Cixi Zhouxiang Jianxi Hardware Fittings Factory, Yueqing Jianrong Electric Meter Fittings Factory, etc. It can also be applied to two-phase electric meter binding posts, various screw-type binding posts, wire connectors, lamp caps, fuses, bakelite knives, inverters, panel switches, inverters, industrial connectors and other electrical equipment. The terminal of the embodiment is a three-phase electric meter terminal 61. The outer surface of the terminal 61 is provided with different color identification areas, and the identification area includes a circular color block 62 on the surface of the wiring hole and a square color at the fastening screw. Block 63, the corresponding Chinese and English characters 64 and the direction arrow 65 are effectively labeled and color-ordered, and the order of the order is yellow, green, red, blue (light blue) from left to right, and is increased. Chinese and English characters and directional arrows with color, the color is printed or inkjet, etc., which is eye-catching and long-lasting. At the same time, Chinese digital control and control 2 are added in the lamp head and wall panel switch. Applicable to different plugs and sockets in different countries, but the color should meet the different requirements of different countries. In addition, the color and direction of the input and output connection power cords are limited, that is, yellow corresponds to the yellow outer skin color wire, green corresponds to the green outer skin color wire, and red corresponds to the red outer skin color wire. The blue (light blue) corresponds to the blue (light blue) outer skin color wire. The present invention provides a striking colored directional arrow in the power cable connection hole to clearly show the power in and out relationship, that is, the power source (power line)→the meter Incoming hole→electric meter outlet hole→circuit breaker→load, further standardize wiring and unification, to meet the general population operation, reduce mistakes, when the user connects the meter, it will consciously correspond to the color, follow the direction arrow prompt, accurately connect, and connect the wrong color difference Obviously, further reduce the misoperation, further improve the quality of the power box, and be more user-friendly.

### Example 7

The invention can be applied to a circuit board plug-in connection terminal, and the products include a splicable screw type PCB terminal block, a plug-in type PCB terminal block, etc., and the manufacturer includes Cixi Kefa Electronics Co., Ltd., Cixi Lianzhe Electronics Co., Ltd., etc. Can be widely used in power conversion circuits, communication signals and other circuits, including plug-in wiring connection terminals, multi-position connectors, terminal blocks, connection line terminals, etc. Products include electrical power supply main board, inverter, phase Xu relay, thermostat electronic instrument, etc. At the terminal

Referring to FIG. 7, the terminal of the embodiment includes eight terminals 71, which are three live terminals, a naught terminal, a earth terminal, a +12V terminal, a +5V terminal and a negative pole from left to right. Terminals. The surface of the outer casing 71 is provided with different color identification areas for effective identification and color sorting. The identification area may specifically include a color block 72 and a Chinese-English character 73 corresponding thereto. The color of the color block corresponding to “L1 [symbol] ” is yellow, the color of the color block corresponding to “L2 [symbol] ” is green, the color of the color block corresponding to “L3 [symbol] ” is red, and the color of the color block corresponding to “N [symbol] ” is blue (shallow Blue), the color of the color block corresponding to “ [symbol] ” is yellow-green color, the color of the color block corresponding to “+12” is dark brown, the color of the color block corresponding to “+5” is brown, and the color of color corresponding to “−” is blue. Color (light blue), that is, the color varies with the depth of the AC DC voltage. The color should meet the different requirements of different countries. After the wrong connection, the color difference is obvious, and it is easy to find the misoperation. When the terminal is applied to the weak current circuit, the color selection of the weak electric signal part should avoid the strong electric color setting.

### Example 8

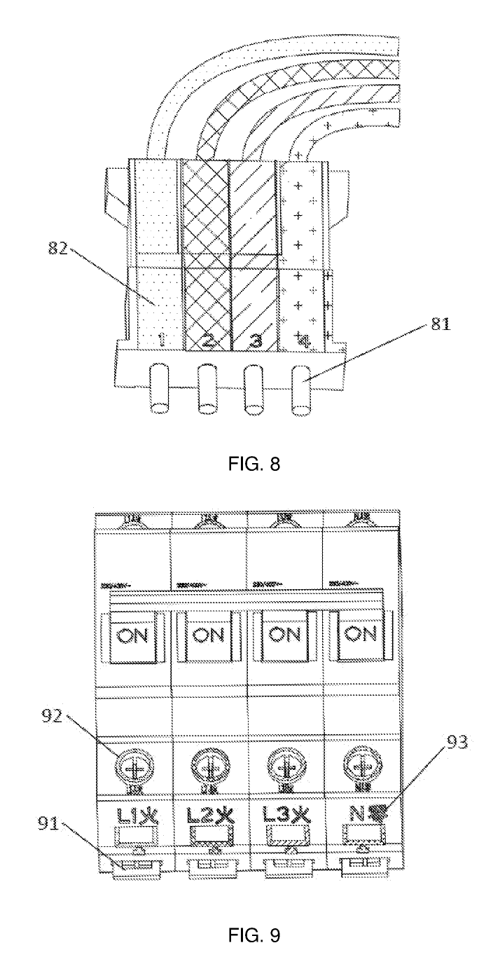

Referring to FIG. 8, the present embodiment is a plug-in type circuit board plug-in connector, such as a household electrical appliance, a computer, a motorcycle, an automobile, and the like, which are manufactured by Zhejiang Hongxing Electric Co., Ltd., and a terminal harness electrical connector and a terminal, including a male and female rubber. Shell and male and female terminals are widely used in power conversion circuits, communication signals, computer power supplies, wiring harnesses and other circuits. The terminal of the embodiment comprises four terminals 81. Four different color identification areas 82 are arranged on the surface of the housing of the plug-in type circuit board plug-in connector for effective identification and color sorting, ie The order of the order is yellow, green, red, blue (light blue) from left to right, the yellow power line corresponds to the yellow power line, the green mark corresponds to the green power line, the red mark corresponds to the red power line, and the blue (light blue) The identification area corresponds to the blue (light blue) power cord. The operator can easily find the wiring error and the product is more beautiful. The color block can also be a single color or a combination of colors.

### Example 9

The invention can be applied to molded case circuit breakers, and the manufacturers include Chint, Hongbo, Shanghai People's Electric, Schneider, ABB, etc., and also include air switches, circuit breakers, leakage circuit breakers, leakage protectors, AC contactors, and analog sockets, surge protector, dual power transfer switch, disconnector, etc. Referring to FIG. 9, the circuit breaker of this embodiment is provided with four terminals 91, which are three live wire terminals and one naught wire terminal from left to right. A ring color patch 92 of different colors and a corresponding Chinese and English character 93 are disposed beside each terminal. It is effectively identified and color sorted. The four color blocks from left to right are yellow, green, red, blue (light blue), and new Chinese and English characters and directional arrows with color are added. L1 [symbol] ” is yellow, corresponding to the yellow arrow and the yellow surrounding ring; “L2 [symbol] ” is green, corresponding to the green arrow and the green surrounding the terminal; “L3 [symbol] ” is red, corresponding to the red arrow and surrounding red Terminals; “N [symbol] ” is blue (light blue), corresponding to blue (light blue) arrows and surrounding blue (light blue) binding posts. When people connect the circuit breaker, four yellow color rings (two are placed around the screw holes and two are placed around the wiring holes) guide the user to connect the yellow power cable, and use the directional arrows and Chinese and English characters to give warnings and corresponding directions. The numerical size represents the order of the phase sequence, and it is easy to find misoperations.

### Example 10

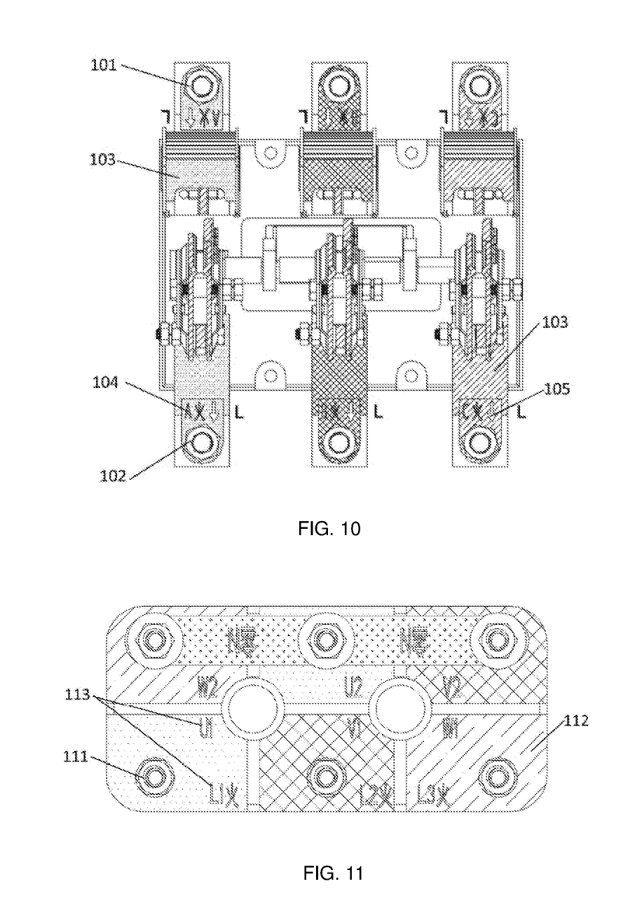

The invention can be applied to a pull rod and a lever type open knife switch. The manufacturers include Shanghai People's Electric, Shanghai Bangkai Electric Co., Ltd., Zhejiang Gubo Power Technology Co., Ltd., Shanghai Jingfeng Electric Co., Ltd., etc., and also include a reverse switch, high-voltage load switch, vacuum switch, oil switch, bakelite knife, two-way knife switch. Referring to FIG. 10, the terminal of the embodiment includes three static blade terminals 101 and three movable blade terminals 102. The traditional blade switches are provided with identification areas corresponding to different colors, specifically including color blocks 103 and Chinese and English characters 104, direction arrows 105, for effective identification and color sorting. The order of the color blocks is yellow, green, and red from left to right. “A [symbol] ” corresponds to the yellow color block and the direction arrow, “B [symbol] ” corresponds to the green color block and the direction arrow, and “C [symbol] ” corresponds to the red color block and the direction arrow. When the open type knife switch is applied to the control cabinet, the installation operator is further restricted. When the untrained ordinary person is wiring, it is easy to connect the yellow power line to the corresponding terminal of the yellow color block and connect the green power line. At the terminal corresponding to the green color block, connect the red power cable to the terminal corresponding to the red color block, and it is easy to form a uniform specification. At the same time, the direction arrow, the number, the Chinese and English characters are used to give warning, and the numerical size represents the order of the phase sequence. After the wrong connection, the color difference is obvious, and it is easy to find the wrong operation, reminding the operator to correct.

### Embodiment 11

The invention can be applied to a motor terminal, and the manufacturer includes Shaoyang Beita Motor Parts Co., Ltd., Yueqing Shoulong Electric Co., Ltd., Wenling Yinwei Electromechanical Parts Factory, and the like. Referring to FIG. 11, the terminals of the present embodiment are three sets of copper joints 111, and color blocks 112 of corresponding colors and Chinese and English characters 113 are disposed around each of the copper joints. The color blocks of four different colors have a one-to-one correspondence with Chinese and English characters. “L1 [symbol] ”, “U1” and “U2” correspond to yellow color blocks, and “L2 [symbol] ”, “V1” and “V2” correspond to green color. Blocks, “L3 fire”, “W1” and “W2” correspond to red color blocks, “N [symbol] ” corresponds to blue (light blue) color blocks, and numbers represent the order of phase sequence.

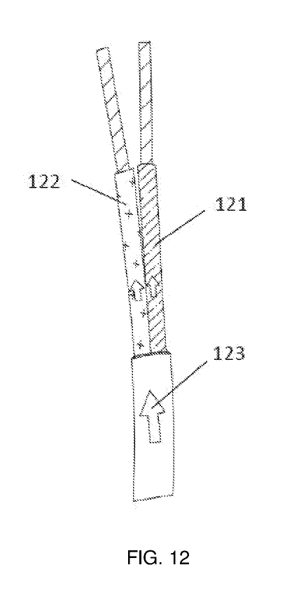

FIG. 12 is a double-core sheathed wire, which further includes a single-core and multi-core power supply line, etc., and is composed of a red power line 121 and a blue power line 122, and a directional arrow 123 is added on the surface thereof to reflect the power in and out relationship. Regardless of the conventional length meter design, the sheath wire is used in conjunction with the electric meter, AC contactor, connecting terminal, circuit breaker, analog socket, knife switch, etc. of the present invention, and the power control box is composed, and the internal structure is clear at a glance. Reasonable and humane.

The terminal provided by the invention is provided with color, letter and Chinese character mark from the power station, for example, A-yellow-live wire, B-green-live wire, C-red-live wire, N-light blue (light blue)-live wire, Two-color (yellow-green)-earth wire, the connection terminals of the supporting booster station-substation-switching station-low-voltage transformer are also set accordingly. The specific settings are as follows:

(1) First, when the generator phase sequence is rotated clockwise, the terminal is set to A-yellow-live wire, B-green-live wire, C-red-live wire. (horizontal from left to right, vertical from top to bottom).

(2) Set a directional arrow on the connected power cord to show the power direction.

(3) The terminals of the step-up transformer and switch are also A-yellow-live wire, B-green-live wire, C-red-live wire. (horizontal from left to right, vertical from top to bottom), the output inputs correspond in parallel.

(4) Conveying high-pressure iron tower porcelain bottle A-yellow-live wire, B-green-live wire, C-red-live wire. (horizontal from left to right, vertical from top to bottom).

(5) User low voltage transformer input is A-yellow-live wire, B-green-live wire, C-red-live wire, output A-yellow-live wire, B-green-live wire, C-red-live wire, N-light blue (light blue)-naught wire (horizontal from left to right, vertical from top to bottom).

(6) User meter box components circuit breaker, air open, electric meter and other terminals are A-yellow-live wire, B-green-live wire, C-red-live wire, N-light blue (light blue)-naught wire (horizontal from left To the right, vertical from top to bottom).

(7) Terminals for low-voltage electrical appliances 380 v or 220 v switches, sockets, thermostats, timers, inverters, power boxes, motors, contactors, relays, etc., marked with color, pattern, letters, Chinese characters, marked with reference to A-yellow-live wire, B-green-live wire, C-red-live wire, N-light blue (light blue)-naught wire, two-color (yellow-green)-ground (horizontal from left to right, vertical from top to bottom).

(8) The user socket, the plug and the plug are set with color markings, which are easy to identify, improve the accuracy of the accurate wiring, and the two-phase plug sets the color mark, so that the fire wire is connected to the electrical equipment to fuse the wire, so as to avoid the entire power circuit being charged after the fuse is blown due to the reverse connection, overcoming The congenital deficiency of the one-way two-phase plug.

The above embodiments are merely illustrative of the embodiments of the present invention and are not intended to limit the scope of the invention. It should be noted that those skilled in the art can make modifications or equivalent substitutions to the technical solutions of the present invention without departing from the scope of the present invention.

1-10. (canceled)

11. A terminal for facilitating identification of an accurate wiring, comprising:
a housing and a plurality of terminals, the terminal extending from the inside of the housing, wherein the housing is provided with a plurality of identification areas; The terminals have a one-to-one correspondence.

12. The terminal of claim 11 for facilitating identification of wiring, wherein said marking area is a planar marking, projection, groove or integral multi-color injection molding on the outer or inner surface of the outer casing.

13. The terminal of claim 12, wherein the identification area is a combination of one or more of a color block, a ribbon, a directional arrow, a wire pattern, a number, and a character.

14. The terminal for accurately identifying the wiring according to claim 13, wherein the color block is a color block having a shape of a circle, a ring, a square or a square around the terminal.

15. The terminal for accurately identifying the wiring according to claim 13, wherein the ribbon is a guide wire that is connected to one end of the terminal.

16. The terminal for accurately identifying the wiring according to claim 13, wherein the characters are One or several combinations of “ [symbol] ”, “ [symbol] ”, “ [symbol] ”, “ [symbol] ”, “ [symbol] ”, “ [symbol] ”, “ [symbol] ”, “ [symbol] ”, “N”, and “L”.

17. The terminal for accurately identifying the wiring according to claim 11, wherein the terminal is a socket, a plug, a knife switch, an air switch, a circuit breaker, an electric meter, an electric motor, a connection terminal, and a power generation. Terminals on the machine or transformer.

18. The terminal of claim 13, wherein the directional arrow is disposed on the terminal itself or on a surface of the power cord or the casing.

19. The terminal for accurately identifying the wiring according to claim 13, wherein the number of the directional arrows is plural, and the entry and exit relationship is embodied.

20. The terminal for accurately identifying the wiring according to claim 13, wherein the protrusion or the groove is one or more, and the shape of the protrusion or the groove is circular or square.
